(19) United States
(12) Patent Application Publication
(10) Pub. No.: US 2018/0328108 A1
(43) Pub. Date: Nov. 15, 2018

(54) HORIZONTAL BLIND

(71) Applicant: Tser Wen CHOU, Yorba Linda, CA (US)

(72) Inventor: Tser Wen CHOU, Yorba Linda, CA (US)

(21) Appl. No.: 15/590,709

(22) Filed: May 9, 2017

(51) Int. Cl. E06B 9/42; E06B 9/382

(52) U.S. Cl. CPC E06B 9/42; E06B 9/40; E06B 9/382

(57) ABSTRACT

A horizontal blind includes a fixing frame, more than one slat control unit and more than one cord winding unit. The fixing frame is mounted on an upper side of a window. The bottom section of the fixing frame has a connection face for connecting with the slat control unit. The slat control unit includes a fixing seat securely connected with the bottom section of the fixing frame and a controlling polygonal barrel received in the fixing seat. The controlling polygonal barrel is connected with a ladder belt to control the rotation of the slats into a horizontal state or a vertical state to shade the sunlight. The cord winding unit is disposed under the fixing seat, including a cord restriction seat, a cord reel passing through the cord restriction seat and a movable conic tube movably fitted on the cord reel for winding the pull cord thereon.

### BACKGROUND OF THE INVENTION

### 1. Field of the Invention

The present invention relates generally to a horizontal blind, and more particularly to a horizontal blind, which has a simplified structure and better sunshade effect and can be quickly installed.

### 2. Description of the Related Art

A conventional horizontal blind structure is such designed that a slat control unit and a pull cord control unit are mounted in a U-shaped rail. With respect to the slat control unit, a fixing bracket must be first mounted in the rail and then a controlling polygonal barrel is mounted. A quadrangular tube is passed through the controlling polygonal barrel and connected to a bead chain control seat. By means of pulling the bead chain, the quadrangular tube is controlled to rotate so as to drive the controlling polygonal barrel to rotate for controlling the rotation of the slats into a horizontal open state or a vertical closed state to shade the sunlight. The pull cord control unit is connected to a lower weight at the bottommost end of the slats via a pull cord. The pull cord is passed through the respective slats to connect with a roller assembly disposed in the rail. After the direction is changed by the roller assembly, the pull cord is further connected to a brake unit. The brake unit serves to control the slats to be pulled and lifted to a fixed position or lowered and suspended in a fixed position. Another pull cord is further suspended from one side of the brake unit, whereby a user can pull the pull cord to control the lifting/lowering of the slats.

The conventional horizontal blind has numerous parts. Therefore, not only the cost for the conventional horizontal blind is higher, but also the installation process of the conventional horizontal blind is quite complicated. Especially, all the parts are positioned in the narrow internal space of the U-shaped rail so that it is quite troublesome and time-consuming to assemble/install the conventional horizontal blind. Moreover, in general, the lifting/lowering of the slats of the conventional horizontal blind is controlled by a bead chain as a power supply unit. This is because all the parts are mounted in the U-shaped rail and only a pull cord can be used as the power supply unit to control the lifting/lowering of the slats. The pull cord cannot be replaced with any other power supply unit. This causes troubles of the user.

### SUMMARY OF THE INVENTION

It is therefore a primary object of the present invention to provide a horizontal blind to solve the above problems of the conventional horizontal blind in installation and operation. The horizontal blind can enhance the sunshade effect and is easier and faster to install. Moreover, the horizontal blind can be equipped with different power supply units so as to lower the cost and speed the installation.

To achieve the above and other objects, the horizontal blind of the present invention includes a fixing frame, more than one slat control unit and more than one cord winding unit. The fixing frame is mounted on an upper side of a window or under a ceiling. The bottom section of the fixing frame has a connection face for connecting with the slat control unit. The slat control unit includes a fixing seat securely connected with the bottom section of the fixing frame and a controlling polygonal barrel received in the fixing seat. The controlling polygonal barrel is connected with a ladder belt, which extends downward to connect with the respective slats so as to control the rotation of the slats into a horizontal open state or a vertical closed state to shade the sunlight. The cord winding unit is disposed under the fixing seat, including a cord restriction seat, a cord reel passing through the cord restriction seat and a movable conic tube movably fitted on the cord reel. The movable conic tube can wind or unwind the pull cord. By means of the guiding of the conic configuration of the conic tube, the pull cord can be more tidily wound on the movable conic tube. A guide roller is disposed at the center of the bottom of the cord restriction seat for guiding the pull cord and locating the pull cord at the center of the slats without tangling. Therefore, the lifting/collection and lowering/dispersion of the slats can be balanced without tilting to enhance the sunshade effect.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective exploded view of the slat control unit of the present invention;

FIG. 3 is a perspective assembled view of the slat control unit of the present invention;

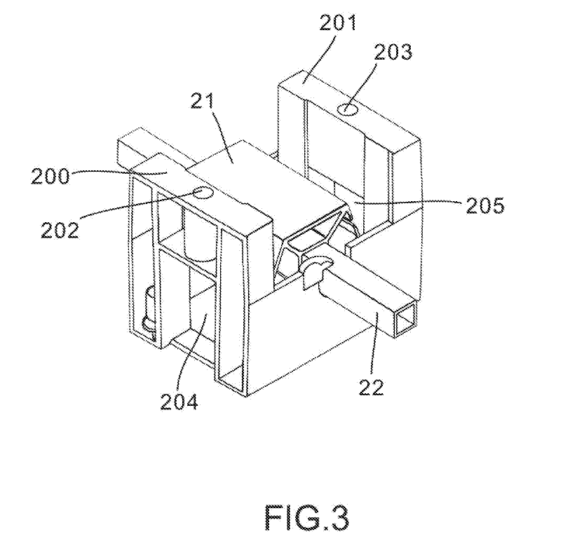

FIG. 4 is a perspective view of the slat control unit of the present invention, showing that a ladder belt is mounted on the slat control unit;

FIG. 5 is a perspective view of the slat control unit of the present invention, showing that a slat is connected to the slat control unit via the ladder belt;

FIG. 6 is a perspective assembled view of the slat control unit of the present invention, showing that the slat control unit is completely assembled;

FIG. 7 is a perspective exploded view of the cord winding unit of the present invention;

FIG. 8 is a perspective view showing the structure of the cord reel of the cord winding unit of the present invention;

FIG. 9 is a plane view showing the structure of the movable conic tube of the cord winding unit of the present invention;

FIG. 10 is a plane view showing that the pull cord is wound on the movable conic tube of the cord winding unit of the present invention;

FIG. 11 is a perspective view showing that the assembly of the present invention is completed;

FIG. 12 is a plane view showing the installation of the present invention;

FIG. 13 is a plane view showing that the present invention shades the sunlight;

FIG. 14 is a perspective exploded view of another embodiment of the slat control unit of the present invention;

FIG. 15 is a perspective view showing the installation of the other embodiment of the slat control unit of the present invention;

FIG. 16 is a perspective view showing the power supply unit for the cord winding unit of the present invention;

FIG. 17 is a perspective view showing another embodiment of the power supply unit for the cord winding unit of the present invention; and

FIG. 18 is a perspective view showing still another embodiment of the power supply unit for the cord winding unit of the present invention.

### DETAILED DESCRIPTION OF THE PREFERRED EMBODIMENTS

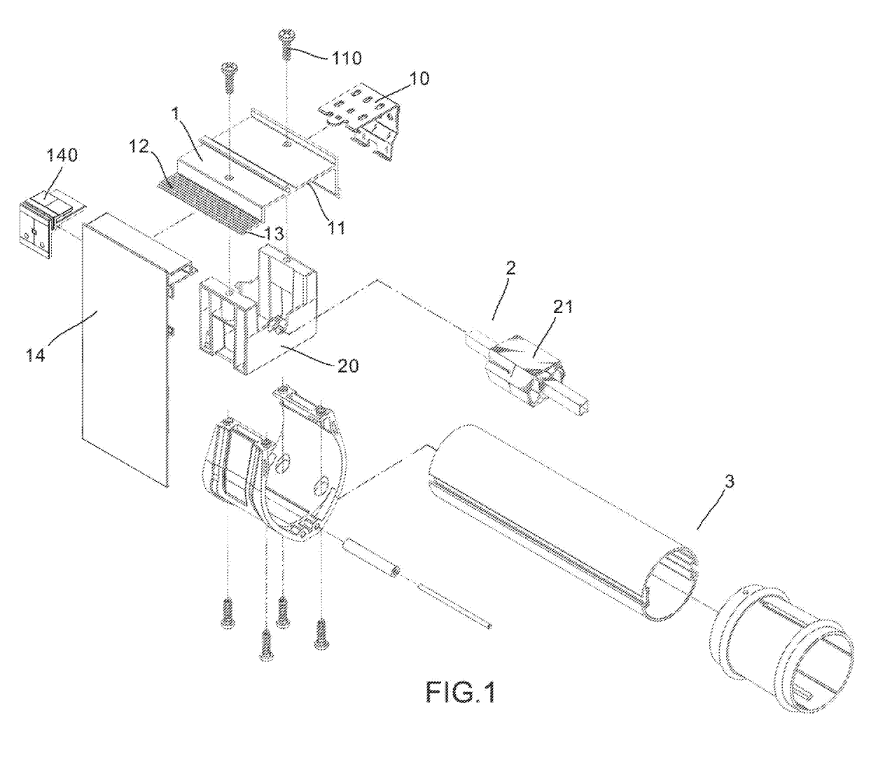

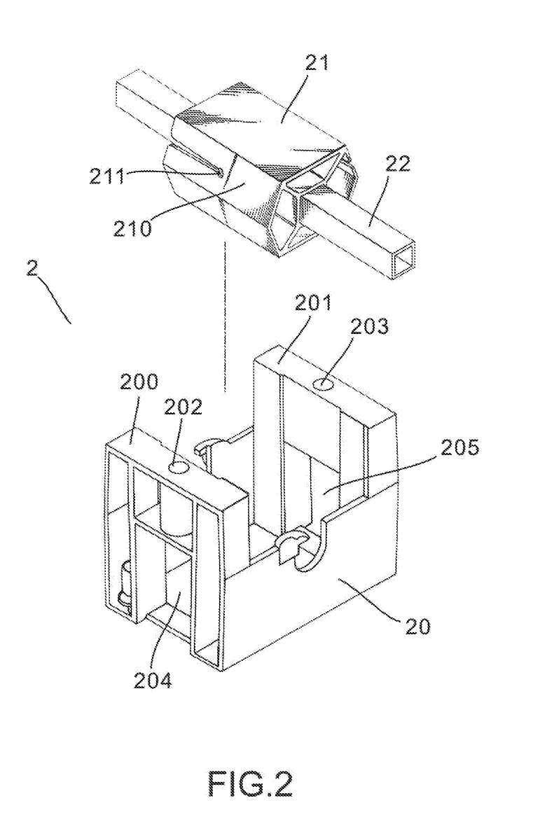

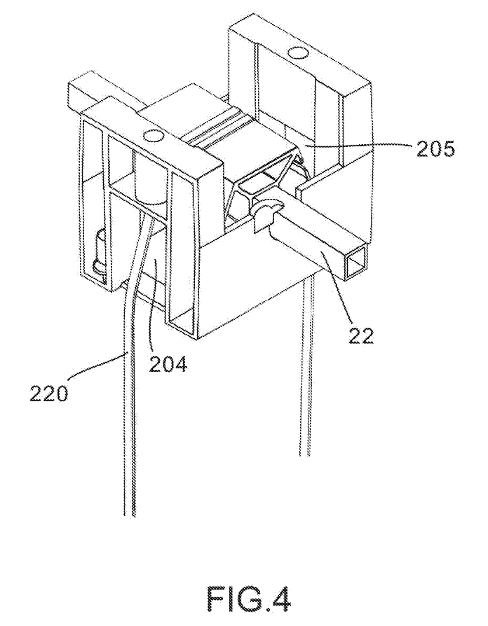

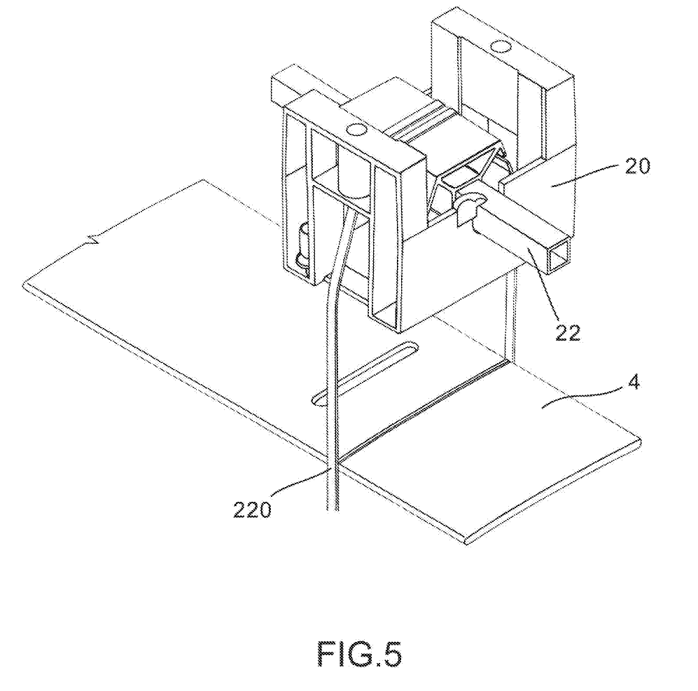

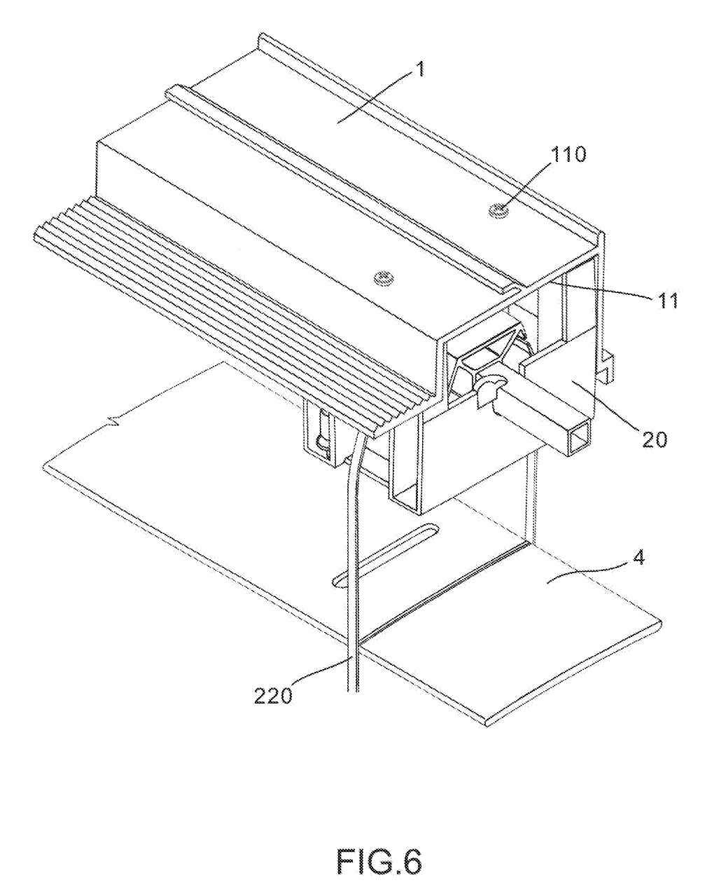

Please refer to FIG. 1. The horizontal blind of the present invention mainly includes a fixing frame 1, more than one slat control unit 2 and more than one cord winding unit 3. As shown in FIG. 1, the fixing frame 1 can be connected with a fixing bracket 10 for securing the fixing frame 1 under a ceiling or on an upper side of a window. The bottom section of the fixing frame 1 is formed with a connection face 11. The slat control unit 2 is securely connected with the connection face 11 by means of screws 110. An engagement board 13 extends from one side of the fixing frame 1. The engagement board 13 is formed with teeth 12. A decorative board 14 can be connected and mounted on the engagement board 13 of the fixing frame 1 via an engagement seat 140 for covering and concealing the slat control unit 2 to beautify the appearance. Please refer to FIG. 2. The slat control unit 2 includes a fixing seat 20 connected with the connection face 11 of the bottom section of the fixing frame 11 and a controlling polygonal barrel 21 connected in the internal space of the fixing seat 20. The main body of the fixing seat 20 is a hollow box body with an opening facing upward. Two lateral sides of the fixing seat 20 are formed with arched notches. Two thread seats 200, 201 are disposed on front and rear sides of the hollow box body. The thread seats 200, 201 are positioned at a height higher than the two lateral sides. The top sections of the thread seats 200, 201 are formed with threaded holes 202, 203. In addition, the thread seats 200, 201 are formed with two perforations 204, 205 for the ladder belt 220 connected with the controlling polygonal barrel 21 to pass through and extend downward to connect the slats. A quadrangular tube 22 is passed through the controlling polygonal barrel 21 and received in the arched notches of the two lateral sides of the fixing seat 20. The quadrangular tube 22 is further connected to a power supply unit for driving the controlling polygonal barrel 21 to rotate. The main body of the controlling polygonal barrel 21 is a hexagonal body composed of six plane faces 210 connected with each other. Two opposite faces of the six plane faces 210 are formed with cord splits 211 for fixing the ladder belt 220 (as shown in FIG. 4). After fixed, the ladder belt 220 passes through the two perforations 204, 205 of the fixing seat 20 to downward extend to connect with the slats 4 (as shown in FIG. 5). After the slat control unit 2 is completely assembled, the fixing seat 20 is secured to the connection face 11 of the bottom section of the fixing frame 11 by means of the screws 110 to complete the assembling process (as shown in FIGS. 6 and 1).

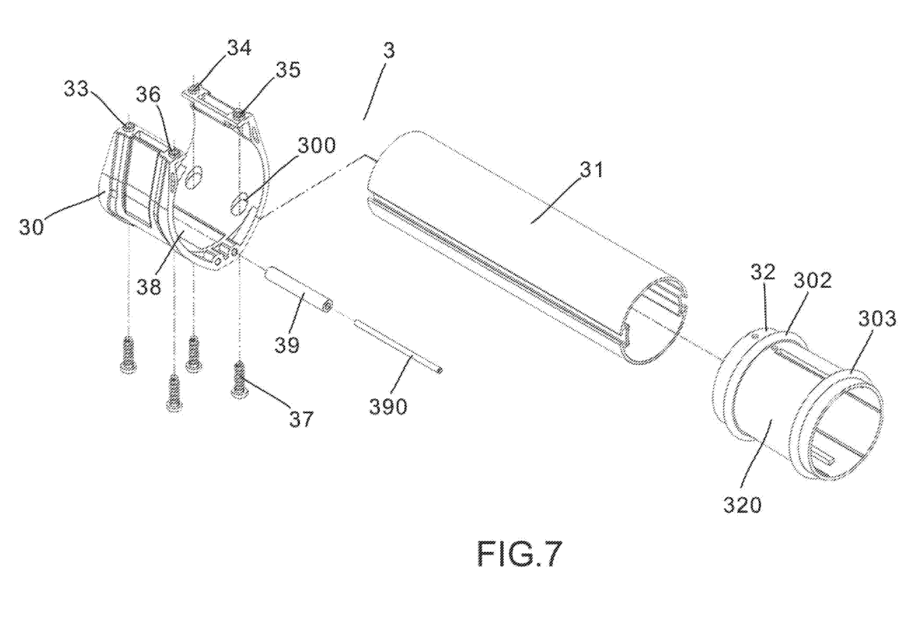

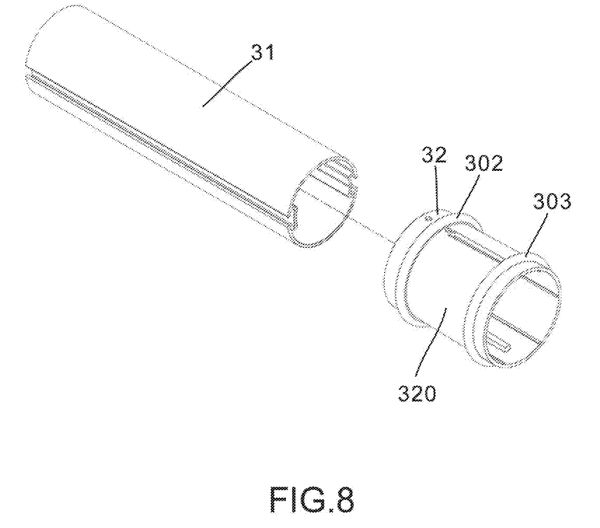

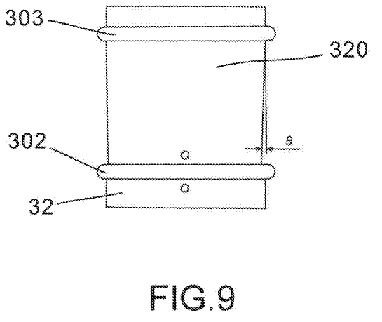

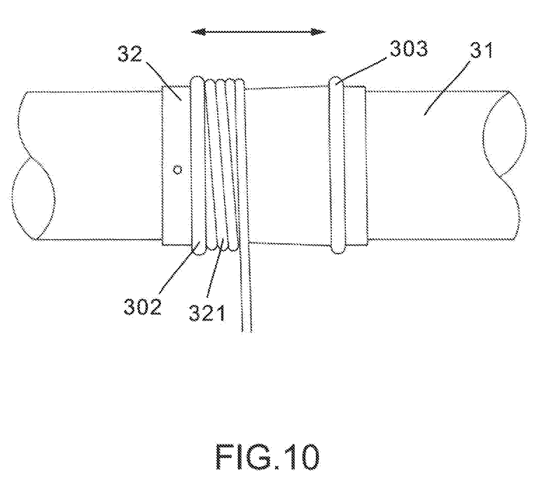

Please now refer to FIGS. 7 and 8. The cord winding unit 3 is secured to the lower side of the fixing seat 20. The cord winding unit 3 includes a cord restriction seat 30, a cord reel 31 passing through the cord restriction seat 30 and a movable conic tube 32 movably fitted on the cord reel 31. The main body of the cord restriction seat 30 is a U-shaped body. Two sides of the top end of the cord restriction seat 30 are formed with threaded holes 33, 34, 35, 36. Screws 37 can pass through the through holes 300 formed on the wall face of the cord restriction seat 30 and the threaded holes 33, 34, 35, 36 to integrally secure the cord restriction seat 30 to the bottom section of the fixing seat 2. In addition, the bottom section of the cord restriction seat 30 is formed with a cord outlet 38. More than one set of guide roller 39 can be mounted in the cord outlet 38. A shaft rod 390 is passed through the guide roller 39, whereby the guide roller 39 can rotate around the shaft rod 390 to guide the pull cord 321 wound on the body of the movable conic tube 32 to extend downward and pass through the slats to further connect with a lower weight so as to control lifting/collection and lowering/dispersion of the slats. The movable conic tube 32 is fitted on the cord reel 31. Two raised ribs 302, 303 are formed on two ends of the body of the movable conic tube 32 to restrict the pull cord to be only wound on a predetermined part of the body of the movable conic tube 32. The body of the movable conic tube 32 is a conic tubular body 320 with a certain angle. By means of the guiding of the conic configuration, the pull cord 321 can be more tidily wound on the movable conic tube 32 without tangling (as shown in FIGS. 9 and 10).

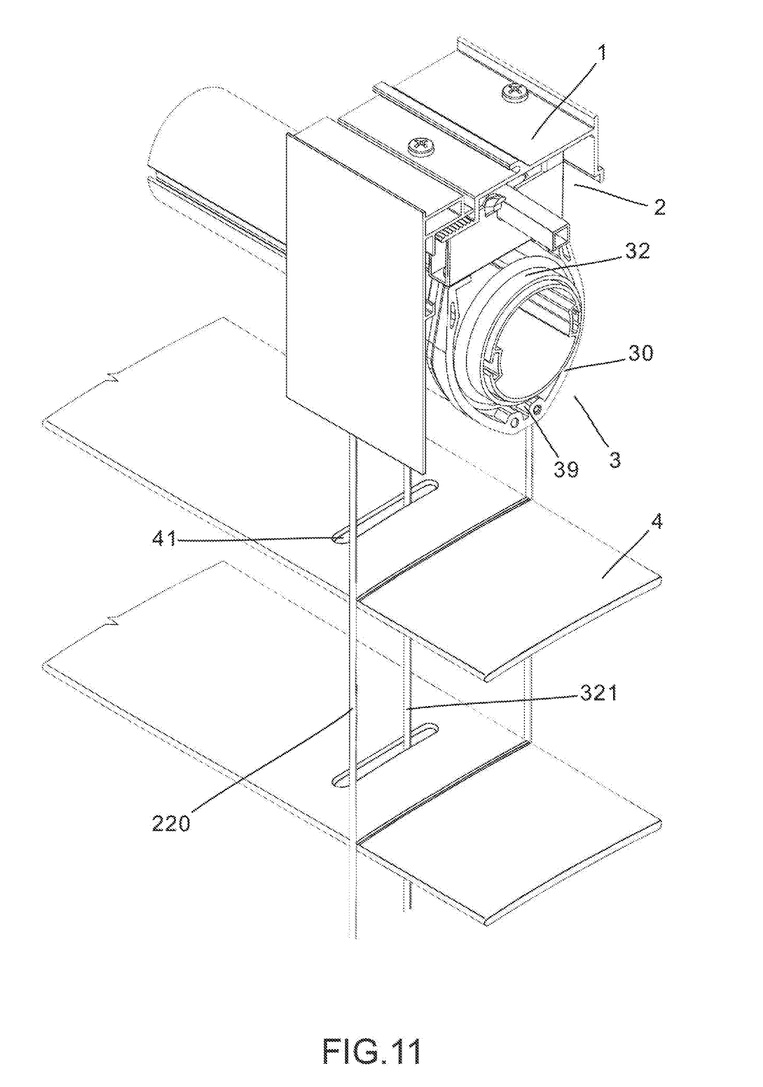

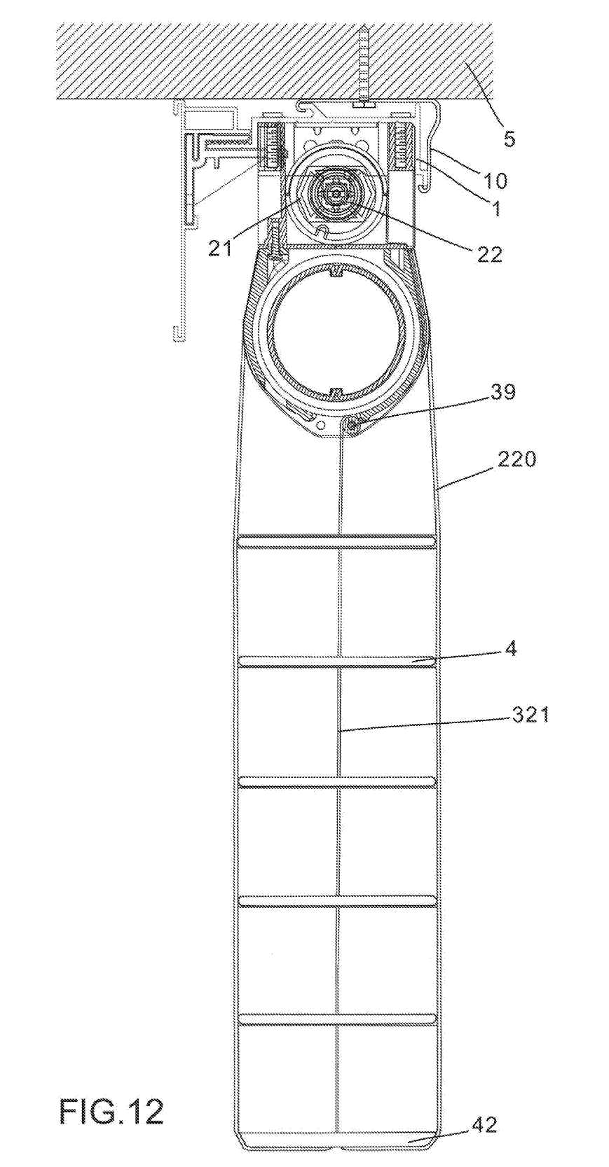

Please now refer to FIG. 11, which shows the assembling process of the present invention. The slat control unit 2 is secured to the lower side of the fixing frame 1. The two ladder belts 220 of the controlling polygonal barrel 21 extend downward to connect with two lateral sides of the respective slats 4. The pull cord wound around the movable conic tube 32 of the cord winding unit 3 extends downward along the inner face of the cord restriction seat 30 to pass through the cord restriction seat 30. The pull cord 321 is guided by the guide roller 39 and is positioned at the center. The pull cord 321 is sequentially passed through the through holes 41 of the slats 4 to connect with the lower weight 42 at the bottom so as to control lifting/collection or lowering/dispersion of the slats 4. By means of the fixing bracket 10 and the fixing frame 1, the entire horizontal blind assembly is securely mounted under the ceiling 5 or on the upper side of the window to complete the assembling/mounting process of the horizontal blind (as shown in FIGS. 11 and 12).

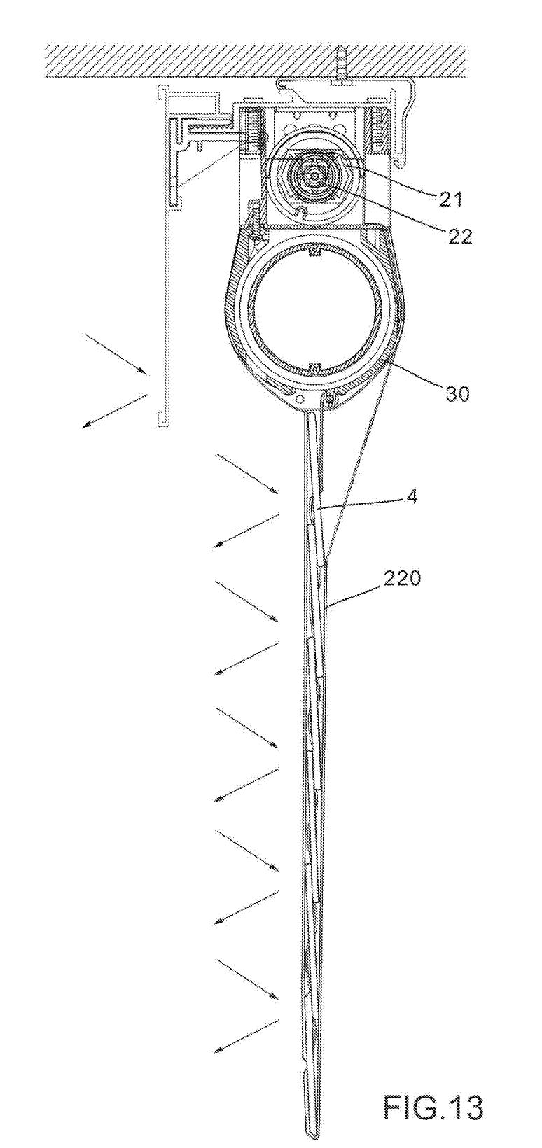

When it is desired to shade the sunlight (as shown in FIG. 13), the power supply unit drives the quadrangular tube 22 to rotate so as to drive the controlling polygonal barrel 21 of the slat control unit 2 to rotate. At this time, one side of the ladder belt 220 is pulled upward, while the other side of the ladder belt 220 is lowered down. The ladder belt 220 is guided by the conic configuration of the cord restriction seat 30, whereby the slats 4 are turned upright to shade the sunlight. At this time, the uppermost slat 4 will abut against the bottom end 30 of the cord restriction seat 30 (as shown in FIG. 13) so that the slats 4 can more snugly attach to each other to enhance the sunshade effect.

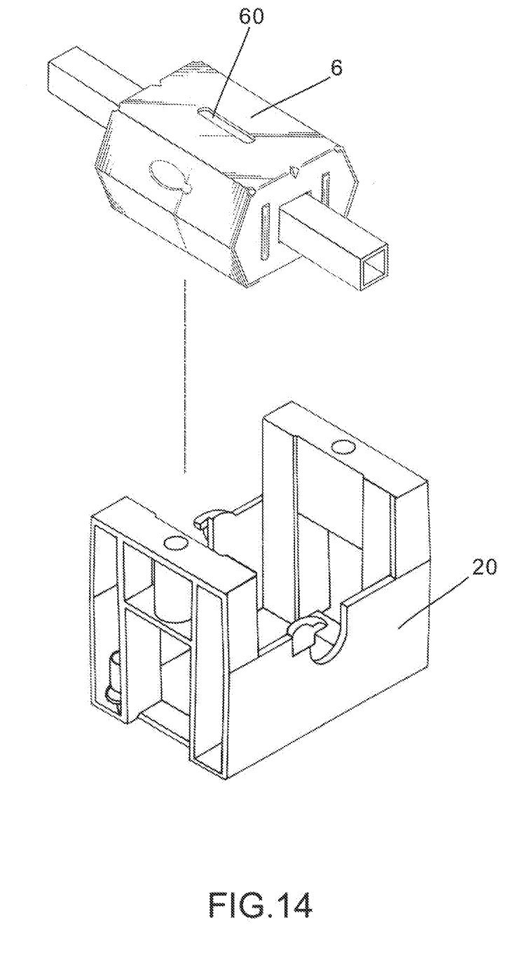

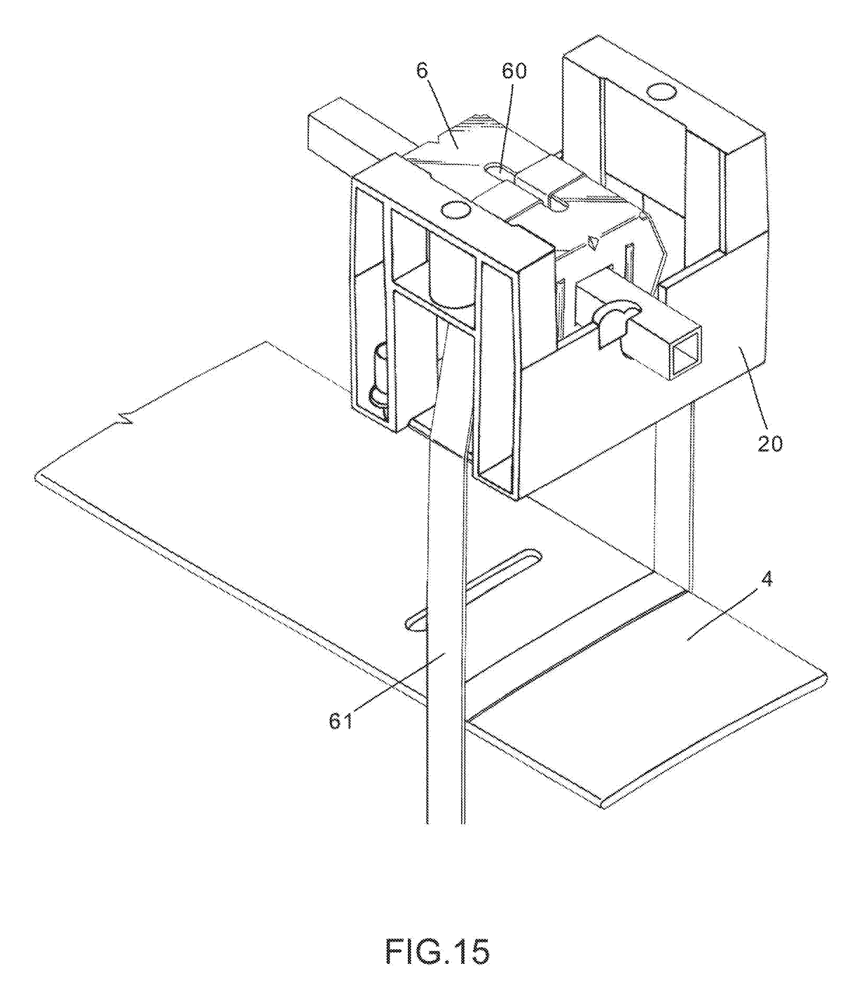

Please now refer to FIG. 14, which shows another embodiment of the controlling polygonal barrel. In this embodiment, the top face of the controlling polygonal barrel 6 is formed with a slot 60. A wide fabric strap 61 is secured to the slot 60. The controlling polygonal barrel 21 is disposed in the fixing seat 20. The wide fabric strap 61 passes through the fixing seat 20 to connect with the respective slats 4. This can also enhance the sunshade effect and facilitate and speed the assembling/mounting process (as shown in FIG. 15).

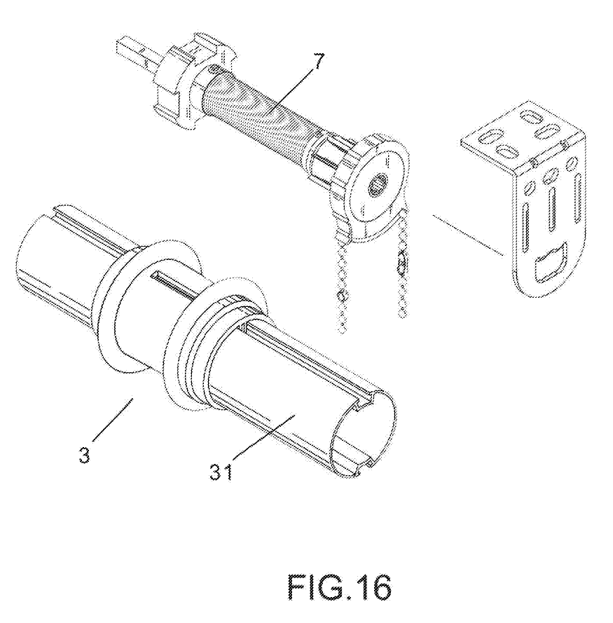

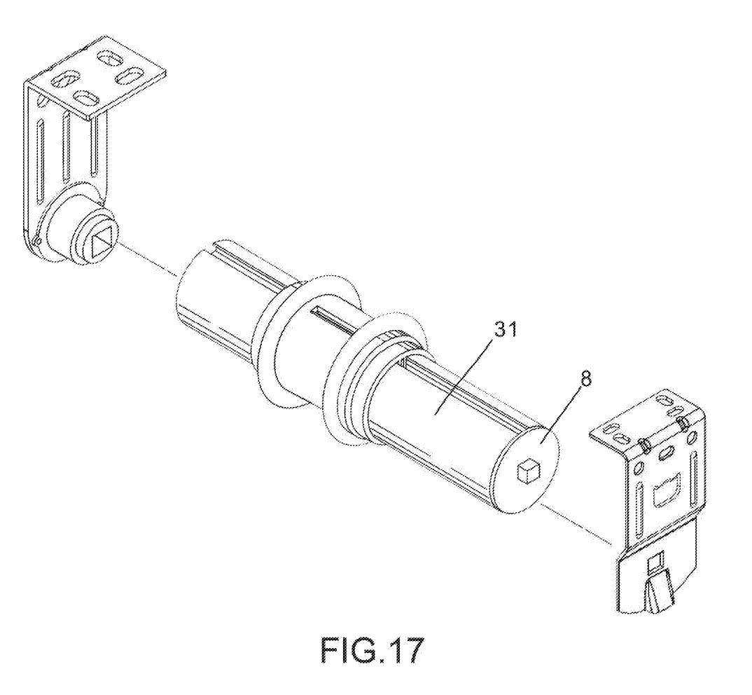

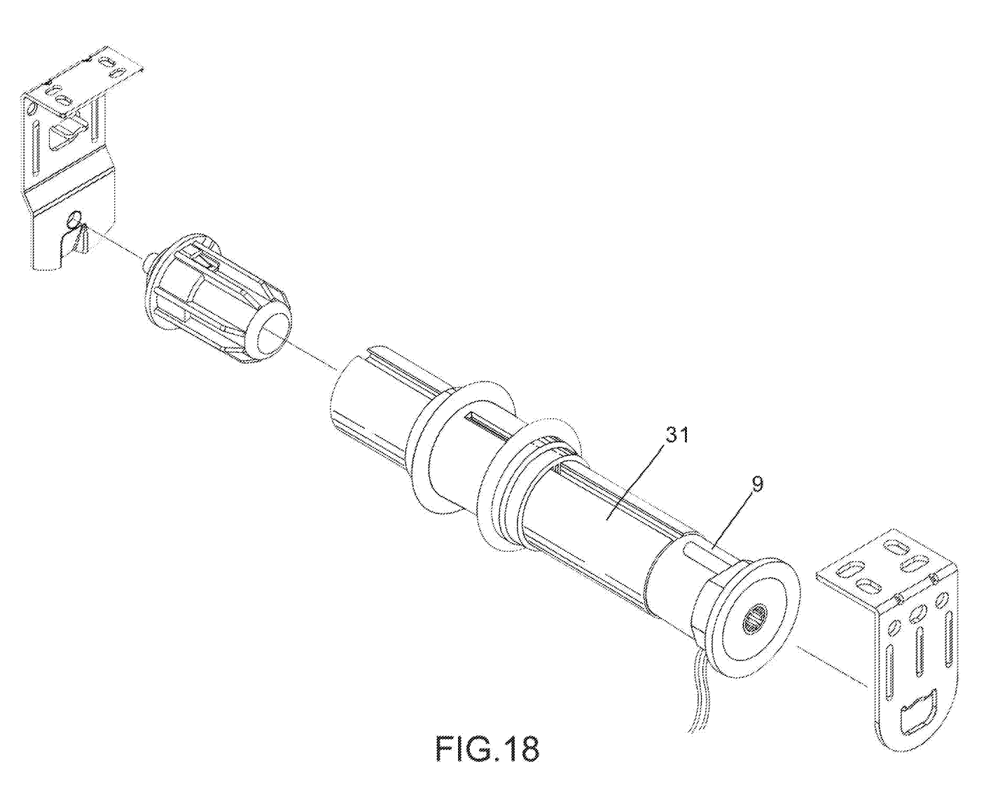

Please refer to FIGS. 16 to 18, which show an embodiment of the power supply unit for providing rotational power to the cord winding unit 3. A bead chain controller 7 or a cordless controller 8 or an automatic winder 9 is mounted on one side of the cord reel 31 of the cord winding unit 3 to provide rotational power for rotating the cord reel 31. Accordingly, the pull cord is driven to lift/collect or lower/disperse the slats.

The above embodiments are only used to illustrate the present invention, not intended to limit the scope thereof. Many modifications of the above embodiments can be made without departing from the spirit of the present invention.

What is claimed is:

1. A horizontal blind comprising:
a fixing frame 1 having a bottom section formed with a connection face, a slat control unit being securely connected with the connection face by means of screws;
more than one slat control unit connected under the fixing frame, the slat control unit including a fixing seat and a controlling polygonal barrel assembled in an internal space of the fixing seat, the fixing seat being a hollow box body with an opening facing upward, thread seats being disposed on front and rear sides of the box body, the thread seats being positioned at a height higher than two lateral sides of the box body, top ends of the thread seats being formed with threaded holes, the thread seats being further formed with two perforations under the threaded holes, whereby a ladder belt connected with the controlling polygonal barrel assembled with the fixing seat can pass through the perforations and extend downward to connect with the respective slats; and
more than one cord winding unit mounted at the lower end of the fixing seat of the slat control unit, the cord winding unit including a cord restriction seat, a cord reel passing through the cord restriction seat and a movable conic tube movably fitted on the cord reel, the cord restriction seat being a U-shaped body, two sides of the top end of the cord restriction seat being formed with threaded holes for securely connecting with the fixing seat by means of screws, a bottom section of the cord restriction seat being formed with a cord outlet, more than one set of guide roller being mounted in the cord outlet for guiding the pull cord wound on the movable conic tube, the movable conic tube being fitted on the cord reel, which is drivingly rotated by a power supply unit, the diameter of the body of the movable conic tube being tapered to form a conic tubular structure, the conic tubular structure serving to guide the pull cord to be tidily wound on the movable conic tube, an end of the pull cord extending along the cord restriction seat to be guided by the guide roller and positioned at the center of the cord restriction seat, the pull cord being sequentially passed through the respective slats to connect with a lower weight so as to control lifting/overlapping or lowering/dispersion of the slats and complete the assembling/mounting process of the horizontal blind.

2. The horizontal blind as claimed in claim 1, wherein two raised ribs are formed on two ends of the body of the movable conic tube to restrict the pull cord to be only wound on a predetermined part of the body of the movable conic tube.

3. The horizontal blind as claimed in claim 2, wherein the body of the movable conic tube is a conic tubular body with a certain angle.

4. The horizontal blind as claimed in claim 1, wherein the cord restriction seat further includes a shaft rod passed through the guide roller, whereby the guide roller can rotate around the shaft rod.

5. The horizontal blind as claimed in claim 1, wherein two lateral sides of the fixing seat are formed with arched notches in which the quadrangular tube of the controlling polygonal barrel is restrictively positioned.
